(19) United States
(12) Patent Application Publication
(10) Pub. No.: US 2010/0176531 A1
(43) Pub. Date: Jul. 15, 2010

(54) PRODUCTION METHOD OF POLYMER FILM

(75) Inventor: Hiromasa Tanaka, Minami-Ashigara-Shi (JP)

Correspondence Address: YOUNG & THOMPSON, 209 Madison Street, Suite 500, Alexandria, VA, 22314, US

(73) Assignee: FUJIFILM Corporation, Tokyo (JP)

(21) Appl. No.: 12/294,944

(22) PCT Filed: Mar. 27, 2007
(86) PCT No.: PCT/JP2007/057367

§ 371 Date: Sep. 29, 2008

(30) Foreign Application Priority Data
Mar. 29, 2006 (JP) 2006-091743

(51) Int. Cl. B29D 7/01

(52) U.S. Cl. 264/216

(57) ABSTRACT

In a mixing tank (12), a TAC is dissolved to a solvent so as to be swollen. Thus a mixture (25) is obtained, and fed to a heating device (15) by driving a pump (26). The heating device (15) heats the mixture (25), such that the solid content in the mixture may be dissolved. The mixture (25) is fed out as a dope (27) from the heating device (15) to a cooling device (16). The dope (27) is cooled down by the cooling device (16) to a surface temperature of a cooling drum (42) onto which the dope (27) is to be cast. Thus impurities containing hemicellulose and the like are precipitated, and the dope (27) is filtrated such that the impurities may be trapped. The dope (27) is cast onto the cooling device (16) while the precipitation of the impurities is prevented after the casting.

### TECHNICAL FIELD

The present invention relates to a production method of a polymer film.

### BACKGROUND ART

A cellulose acylate film is formed from cellulose acylate. For example, especially cellulose triacetate (hereinafter TAC) film is formed from TAC whose averaged acetylation degree is in the range of 58.0% to 62.0%. The TAC film is used as a film base of a film material, such as a photosensitive material, since having strength and inflammability. Further, the TAC film is excellent in optical isotropy, and therefore used as a protective film in a liquid crystal display whose market becomes larger in recent years.

The TAC film is usually produced by a solution casting method, in which the produced film is more excellent in physical properties, such as optical properties and the like, than other film production methods such as a melt extrusion method. The reason therefore is that the raw materials for producing the film are hardly damaged thermally. For the solution casting method, a polymer is dissolved to a mixture solvent in which dichloromethane or methyl acetate is main solvent component, and thus a dope as a polymer solution is prepared. Then the dope is cast from a casting die onto a support so as to form a casting film, while a bead of the dope is formed between the casting die and the support. When the casting film has a self-supporting property, the casting film is peeled as a wet film from the support. The wet film is dried in a transfer area, and then stretched in a widthwise direction and dried by a tenter device. After the stretch, the wet film is dried again and wound up.

In recent years, since the demand for the liquid crystal display becomes larger, the demand for the TAC film also increases extremely. Therefore, the increase of the production speed is required. As the support, a casting belt or a casting drum is used. If the casting belt is used as the support, the casting belt is supported by back-up rollers, and the temperatures of the casting belt and the back-up rollers are controlled to respective predetermined values. Then the casting film formed on the casting belt is dried by applying a drying air, so as to have self supporting properties gradually. Therefore it is hard to increase the production speed.

If the casting drum is used, a surface temperature thereof is lower than the dope, such that the casting film to be formed may be a gel-like film. Thus the casting film has self supporting properties rapidly after the casting. Therefore, the production speed can be made higher than when the casting belt is used. Note in the present invention that the casting drum whose surface is cooled is named a cooling drum.

If the cooling drum is used, however, although the casting film has the self supporting properties rapidly, the temperature of the dope is low, and therefore impurities contained in the dope is precipitated on the cooling drum. In this case, the peeling defect and the smoothness of the peeled film become lower. As a result, the film production line is stopped, and therefore the productivity extremely decreases. In order to prevent such problems, the cleaning of the cooling drum is made. However, in this case, the production line is punctually stopped and otherwise it is necessary to make the production speed lower, which cause the lower productivity.

Japanese Patent Laid-Open Publication No. 2003-276038 discloses a solution casting method of producing a cellulose acylate film. In this publication, the dope contains organic solvent components, such as citric acid, esters thereof and the like, which has such a solubility than the precipitations of salts of alkali metal and salts of alkali earth metal are prevented.

However, as the impurities which have precipitated on the casting drum, there are hemicellulose and the like, other than salts of alkali metal and alkali earth metal. In the method of the above publication, the hemicellulose and the like cannot be removed.

An object of the present invention is to provide a production method of a polymer film, in which the precipitation of impurities, especially hemicellulose, from the dope on the cooling drum is prevented.

### DISCLOSURE OF INVENTION

In order to achieve the object and the other object, in a production method of a polymer film, a polymer and a solvent are mixed such that a swelling liquid in which the polymer is swollen by the solvent may be obtained, a mixture is obtained by dissolving a polymer to a solvent, the swelling liquid is heated so as to produce a casting dope, and then the casting dope is cooled to about a surface temperature of the support such that impurities may be precipitated in the casting dope. The impurities are trapped from the casting dope. The impurities are trapped from the casting dope, and the casting dope is cast onto a support, so as to form a casting film. Then the casting film is dried such that a polymer film may be obtained.

Preferably, the casting film has a multi-structure having a first film contacting to the support and a second layer disposed on the first film, and the first layer is formed from the casting dope after the cooling step and the trapping step.

Preferably, the casting dope is cooled in the range of a surface temperature of the support and 38° C., and the trapping is made by a filtration.

Preferably, a surface temperature of the support is in the range of −30° C. to 0° C. A temperature of the swelling liquid during the heating is in the range of 40° C. to 120° C. A poor solvent containing hydroxyl group is added to the casting dope after the trapping step.

Preferably the casting dope is concentrated. Particularly preferably the trapping step is made after the concentrating step.

Preferably the impurities contain hemicellulose.

According to the present invention, a polymer is dissolved to a solvent, such that a mixture may be obtained. The mixture is heated to be a dope, and then the dope is cooled to about a surface temperature of the support such that impurities may be precipitated in the casting dope. The impurities are trapped from the casting dope, and the casting dope is cast onto a support, so as to form a polymer film. Thus the impurities are precipitated previously in a dope production line, and thus the impurities to be precipitated on the support are reduced at most. Therefore the pollution on the support is almost prevented.

### BRIEF DESCRIPTION OF DRAWINGS

FIG. 1 is a schematic diagram of a first embodiment of a dope production line of the present invention;

FIG. 2 is a schematic diagram of a film production line;

FIG. 3 is a schematic diagram of a second embodiment of a dope production line of the present invention.

### BEST MODE FOR CARRYING OUT THE INVENTION

As polymer of this embodiment, cellulose acylate is preferable, and triacetyl cellulose (TAC) is especially preferable. TAC may be produced from cotton linter or cotton pulp, or a mixture of materials respectively obtained from cotton linter and cotton pulp, and preferable TAC is produced from cotton linter. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 mass. % of TAC is particles having diameters from 0.1 mm to 4 mm.

2.5≦A+B≦3.0 (I)

0≦A≦3.0 (II)

0≦B≦2.9 (III)

Further, polymer to be used in the present invention is not restricted in cellulose acylate.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particularly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two, sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88.

Further, DSB is preferably at least 0.30, and especially at least 0.7. According to DSB, the percentage of the substitution on the 6^{th} position to that on the 2^{nd}, 3^{rd} and 6^{th} positions is at least 20%. However, the percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability.

Cellulose as raw material of acylate cellulose is may be obtained from one of linter cotton and pulp cotton. As sorts of the pulp, there are hardwood pulp made from broadleaf trees and softwood pulp made from needle-leaved tree. The preferable one is the softwood pulp since it contains smaller impurities than the hardwood pulp.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinnamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinnamoyl group and the like, and the especially preferable groups are propionyl group and butanoyl group.

Further, as solvents for preparing the dope, there are aromatic hydrocarbons (for example, benzene, toluene and the like), hydrocarbon halides (for example, methylene chloride, chloroform, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent. It is to be noted in the present invention that the dope is a polymer solution or a dispersion liquid that is obtained by dissolving or dispersing the polymer in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, and esters having 3 to 12 carbons are preferable, and a mixture thereof can be used adequately. These ethers, ketones and esters may have the ring structure. Further, the compounds having at least two of functional groups in ethers, ketones and esters (namely, —O—, —CO— and —COO—) can be used for the solvent. Further, if the organic solvent component has at least two functional groups, the number of the carbon atoms may be in the range which is predetermined for one of the functional groups, and it is not restricted especially.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, retardation controller, dynes, matting agent, release agent, releasing improver and the like) is made from to [0516] in Japanese Patent Laid-Open Publication No. 2005-104148.

[Dope Production Method]

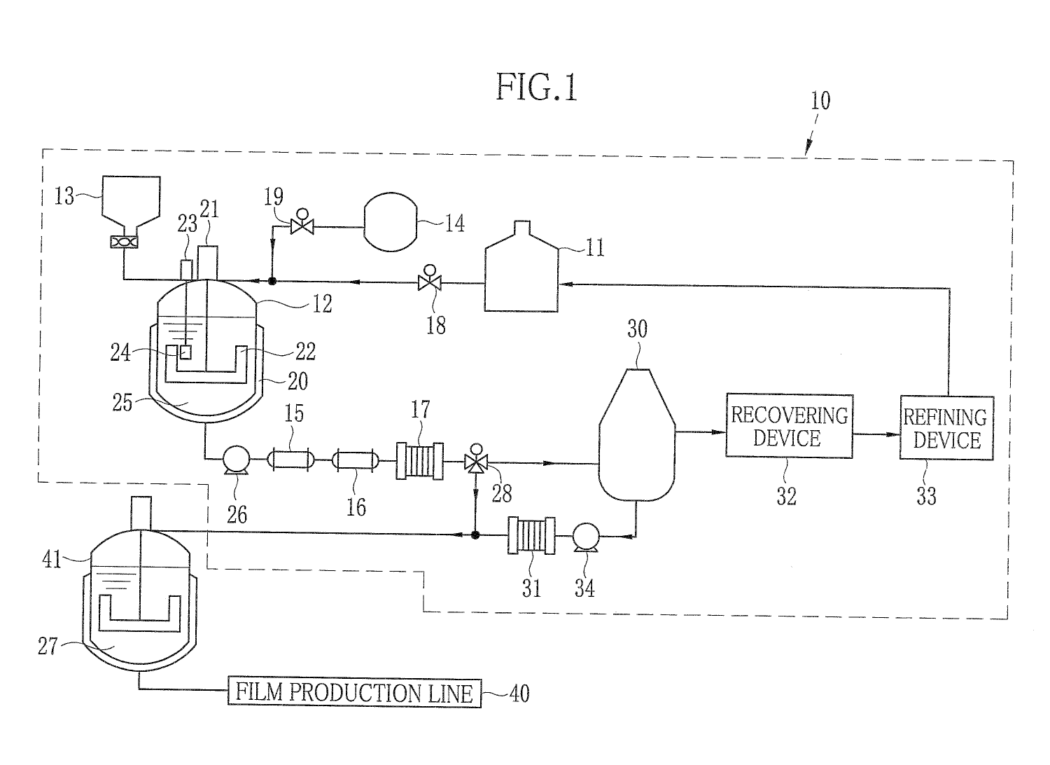

As shown in FIG. 1, a dope production line 10 is constructed of a solvent tank 11 for storing a solvent, a mixing tank 12 for mixing the TAC and the solvent therein, a hopper 13 for supplying the TAC and an additive tank 14 for storing an additive. Further, there is a heating device 15 for heating a swelling liquid (described below in detail), a cooling device 16 for controlling the temperature of prepared polymer solution, and a filtration device 17. Further, there are a flush device 30 for concentrating the polymer solution and a filtration device 31. Further, there are a recovering device 32 for recovering a solvent vapor, and a refining device 33 for refining and recycling the recovered solvent. The dope production line 10 is connected through a stock tank 41 to a film production line 40. Note that the explanation of the stock tank 41 will be made later.

In the dope production line 10 are performed a dope preparing process, a dope cooling process, a filtration process, a concentrating process and a refining process.

In the dope preparing process, a dope 27 is produced in the following order. When a valve 18 is opened, the solvent is sent from the solvent tank 11 to the mixing tank 12. Amount of the solvent is controlled by adjusting the valve 18. Then the TAC in the hopper 13 is sent to the mixing tank 12. Thereafter, a valve 19 is opened such that the additive is sent from the additive tank 14 to the mixing tank 12.

The method of feeding the additive to the mixing tank is not restricted in the above description. If the additive is in the liquid state in the room temperature, it may be fed in the liquid state to the mixing tank 12 without preparing for the additive solution. Otherwise, if the additive is in the solid state in the room temperature, it may be fed in the solid state to the mixing tank 12 with use of a hopper. If plural sorts of additive compounds are used, the additive containing the plural additive compounds may be accumulated in the additive tank 14 altogether. Otherwise plural additive tanks may be used so as to contain the respective additive compounds, which are sent through independent pipes to the mixing tank 12.

In the above explanation, the solvent, the TAC, and the additive are sequentially sent to the mixing tank 12. However, the sending order is not restricted in it. For example, after the predetermined amount of the TAC is sent to the mixing tank 12, the feeding of the predetermined amount of the solvent and the additive may be performed to obtain a TAC solution. Otherwise, it is not necessary to feed the additive to the mixing tank 12 previously, and the additive may be added to a mixture of TAC and solvent in following processes.

The mixing tank 12 is provided with a jacket 20 covering over an outer surface of the mixing tank 12, a first stirrer 22 to be rotated by a motor 21, and a second stirrer 24 to be rotated by a motor 23. The jacket is provided with a temperature controlling device for controlling the temperature of a heat transfer medium flowing in the jacket. Thus the inner temperature in the mixing tank 12 is controlled, preferably in the range of 25° C. to 38° C., particularly 28° C. and 37° C., and especially 30° C. and 36° C. At least one of the first and second stirrers 22, 24 is adequately chosen for performing the rotation. Thus a mixture (or a swelling liquid) 25 in which the TAC is swollen in the solvent is obtained. The first stirrer 22 preferably has an anchor blade, and the second stirrer 24 is preferably an eccentric stirrer of a dissolver type.

A pump 26 is driven such that the mixture 25 in the mixing tank 12 may be sent to the heating device 15 which is preferably a pipe with a jacket. While the heating device 15 heats the mixture 25, the dissolution of TAC proceeds such that the mixture 25 may be a polymer solution. Note that the polymer solution may be a solution in which the polymer is entirely dissolved or a swelling liquid in which the polymer is swollen. Further, the temperature of the mixture 25 is preferably in the range of 40° C. to 120° C., particularly 60° C. to 110° C., and especially 80° C. to 100° C. Thus, in the heating device 15, the mixture 25 is heated preferably in the range of 40° C. to 120° C., particularly 60° C. to 110° C., and especially 80° C. to 100° C. After the heating, the mixture is fed out as the dope 27 from the heating device 15 to the cooling device 16. In the heating device 15, if the temperature of the mixture 25 becomes at least 120° C., the raw materials contained in the mixture 25 are damaged in effect of the thermal energy. Note that the heating device 15 preferably has a pressuring function for pressuring the mixture 25, such that the dissolution of the TAC to the solvent may proceed.

In the dope cooling process, the dope 27 heated by the heating device 15 is cooled by a cooling device 16. The temperature in the cooling device 16 is preferably in the range of −40° C. to 10° C., particularly −30° C. to 0° C., and especially −20° C. to −10° C. Thus it is preferable that the cooling device 16 cools the dope 27 to a temperature, preferably in the range of −40° C. to 10° C., particularly −30° C. to 0° C., and especially −20° C. to −10° C. The dope prepared by heating in the heating device 15 is cooled by the cooling device disposed in downstream from the heating device 15. Especially if the cooling of the dope 27 heated to a high temperature by the cooling device 16 is made rapidly, a lot of the impurities are precipitated. In this case, when the dope 27 heated to the high temperature by the heating device 15 is cooled rapidly, a lot of impurities are precipitated. In order to precipitate more impurities, it is preferable that the temperature difference of the dope 27 between the heating device 15 and the cooling device 16 may be in the range of 80° C. to 130° C., particularly 90° C. to 130° C., especially 90° C. to 120° C., and most especially 100° C. to 110. Note that the impurities to be precipitated contain hemicellulose and the like.

In the filtering process, the filtration of the dope 27 is made with use of the filtration device 17, so as to remove the impurities precipitated in the cooling process and foreign materials from the dope 27. The filtration device 17 preferably has a filter. An averaged porous diameter of the filter is preferably in the range of 1 μm to 20 μm, particularly 3 μm to 15 μm, and especially 5 μm to 10 μm. The flow rate of the filtration in the filtration device 17 is preferably in the range of one liter/hr to 15 liter/hr, particularly 1.5 liter/hr to 10 liter/hr, and especially 2 liter/hr to 5 liter/hr. Further, a primary filtration pressure in the filtration device 17 is preferably in the range of 0.5 MPa to 5 MPa, particularly 1 MPa to 4 MPa, especially 1.5 MPa to 3 MPa. Further, a secondary filtration pressure in the filtration device 17 is preferably in the range of 1 MPa to 10 MPa. Note that a poor solvent having hydroxyl group may be added after the filtration.

In the dope preparing method as described above, it takes long time to produce the dope 27 of the higher concentration. Therefore, if it is designated that the dope 27 to be prepared has the higher concentration, the valve 28 is opened so as to perform the concentrating process. Thus the dope 27 is prepared to have a lower concentration of a predetermined value at first, and then concentrated so as to have a higher concentration of a predetermined value. When the valve 28 is opened, the dope 27 of the lower concentration is fed to the flush device 30, and then part of the solvent evaporates therein. Thus the concentration of the polymer in the dope 27 becomes higher so as to be preferably in the range of 20 mass % to 30 mass, particularly 21 mass % to 27 mass %, and especially 22 mass % to 25 mass %. Further, at the flushing, the temperature of the dope 27 is controlled preferably in the range of 60° C. to 110° C., particularly 75° C. to 95° C., and especially 80° C. to 90° C. After the concentration, the dope 27 is taken out or extracted from the flush device 30 by a pump 34, filtrated by the filtration device 31 and sent to the stock tank 41. In the extraction of the dope 27 from the flush device 30, the defoaming is preferably made to remove the foams from the dope 27. For defoaming, there are several methods already known, for example an ultrasonic wave method. The dope 27 after the filtration process is sent to the concentrating process or the stock tank 41 (a storing process).

In the refining process, the solvent vapor generated by evaporating the solvent in the flush tank 30 is condensed by a condenser (not shown) disposed in the flush tank 30, and thus the liquidation of the solvent vapor is made. Then the liquidized solvent is recovered by the recovering device 32 and refined by the refining device 33. Thereafter the refined solvent is fed to the solvent tank 11 and reused for preparing the dope.

In this embodiment, the cooling device 16 is disposed between the heating device 15 and the filtration device 17, so as to cool the dope. Thus the impurities in the dope 27 are precipitated. In addition to or instead of the precipitation, a cooling device (not shown) may be disposed between the flush device 30 and the filtration device 31, so as to be precipitated the impurities in the dope 27. Note that the temperature in the cooling device or that of the dope 27 cooled by the cooling device may be the same as or different from that of the dope 27 in both of the cooling device.

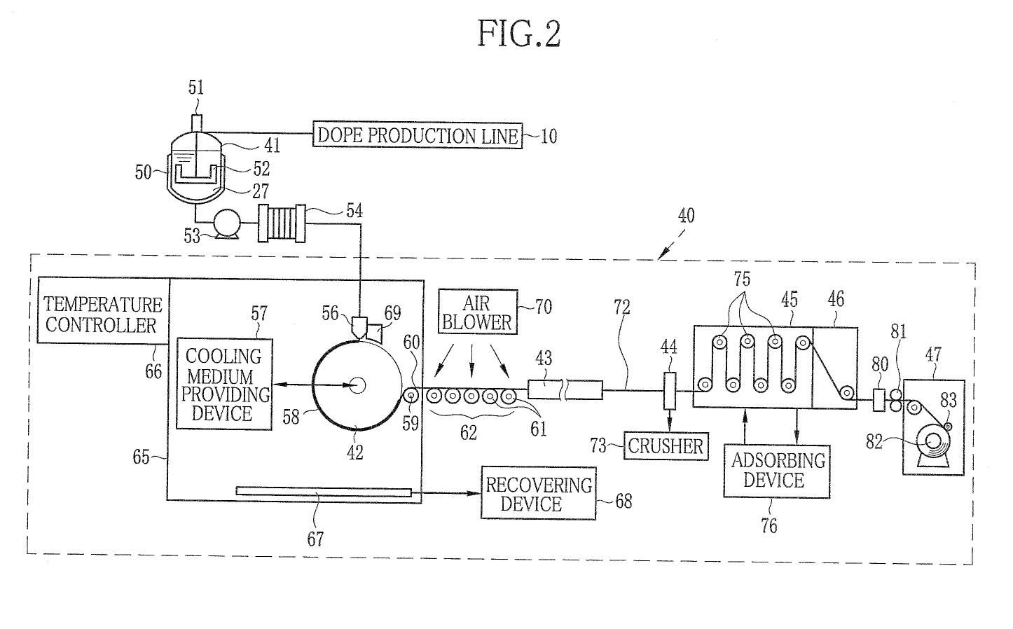

If it is designated to wind up a film 72 as a produced film in a winding device 47 (see, FIG. 2), the dispersion liquid may be added in order to prevent the adhesion of different parts of the film 72 in a film roll. The dispersion liquid is obtained by mixing particles of matting agents and predetermined solvent components. In the dispersion liquid, predetermined additives may be contained in addition to the particles and the solvent components. Preferably, the dispersion is added to the dope 27 in a line connecting the stock tank 41 to the casting chamber, and after the addition, the stirring may be made. However, the addition is not restricted in this embodiment.

[Solution Casting Method]

An embodiment of the solution casting method for producing a film of the present invention will be described in reference with FIG. 2, now. However, the present invention is not restricted in the embodiment. As shown in FIG. 2, the film production line 40, to which the stock tank 41 is connected through a filtration device 54, includes a casting die 56, the cooling drum 42, and a tenter device 43. Further, there are an edge slitting device 44, a drying device 45, a cooling device 46 and the winding device 47.

The stock tank 41 includes a jacket 50 covering over the outer surface of the stock tank 41 and a stirrer 52 rotated by a motor 51. The temperature of the stock tank 41 is controlled by feeding a heat transfer medium (not shown) in the jacket 50, and preferably in the range of 25° C. to 38° C., particularly 28° C. to 37° C., and especially 30° C. to 36° C. In the stock tank 41, the temperature of the dope 27 is preferably in the range of 25° C. to 38° C., particularly 28° C. to 37° C., and especially 30° C. to 36° C. The stock tank 41 is connected through the filtration device 54 to the casting die 56 for casting the dope 27 on the cooling drum 42. Therefore, the dope 27 in the stock tank 41 is fed to the casting die 56 in accordance with the drive of a pump 53, and cast from the casting die 56 onto the cooling drum 42 so as to form a casting film 58.

The cooling drum 42 is rotated by a driving device (not shown). The surface temperature of the cooling drum 42 is preferably in the range of −50° C. to 20° C., particularly −40° C. to 10° C., and especially −30° C. to 0° C. If the surface temperature is less than −50° C., the distension condition of the surface of the cooling drum 42 is changed, which sometimes prevents the formation of the smooth film surface. If the surface temperature is more than 20° C., the gelation of the dope 27 doesn't proceed, and therefore when the rotation speed is made higher, the productivity cannot be higher.

The cooling drum 42 is provided with a cooling medium providing device 57 for controlling the surface temperature of the cooling drum 42 to a predetermined value. The cooling medium providing device 57 circulatory feeds a cooling medium into the cooling drum 42. Thus after the casting of the dope 27 is made, the casting film formed on the cooling drum 42 is cooled such that the gelation of the casting film may proceed. Thus the casting film has self-supporting properties, and thereafter peeled as a wet film 60 from the cooling drum 42 by a roller 60. The wet film 60 is transported by rollers 61 provided in a transfer area 62. At the peeling, the content of remaining solvent in the wet film 60 is in the range of 100 mass % to 200 mass % on dry basis. Note that the content of the remaining solvent in the wet film 60 is that on dry basis and measured with use of the samples of the wet film 60 and the produced film which is completely dried. If the sample weight of the wet film 60 was x and the sample weight after the drying was y, the solvent content on the dry basis (%) was calculated in the formula, {(x−y)/y}×100. Note that the wet film 60 is transported to the transfer area 62 in which a lot of rollers 61 are provided.

The width of the cooling drum 42 is not restricted especially. However, it may be 1.1 to 1.2 times larger than the casting width of the dope 27. The surface of the cooling drum 42 is grind such that the surface roughness of thereof may be at most 0.05 μm. The cooling drum 42 is produced of stainless, especially of SUS 316 so as to have the enough resistance to corrosion and the strength. The cooling drum 42 preferably has no surface defects.

The casting die 56 and the cooling drum 42 are disposed in the casting chamber 65 which is provided with a temperature controller 66. Thus the inner temperature of the casting chamber 65 is controlled by the temperature controller, and preferably in the range of −10° C. to 57° C. Further, in the casting chamber 65, there is a condenser 67 for condensing the solvent vapor which has occurred through the evaporation of the organic solvent. The solvent after the condensation is recovered to a recovering device 68 disposed outside the casting chamber 65. Further, a decompression chamber 69 is attached to the casting die 56, so as to control the pressure in the upstream side from the bead formed by the discharged bead 27.

In the transfer area 62, there is an air blower 70. In the downstream from the transfer are 62, a tenter device 43 is disposed. The tenter device 43 has pin clips (not shown), and the wet film 60 is dried while side edge portions of the wet film 60 are kept by sticking the pin clips thereto. In the tenter device 43, while the drying is made, the pin clips stretch and pull the wet film 60 tightly, and thus the tension is applied so as to make the stretch of the wet film 60 in the widthwise direction. Then the wet film 60 is fed out as the film 72. Note that a tenter device of a clipping type may be provided between the tenter device 43 and the edge slitting device 44. Thereafter the film 72 is fed to the edge slitting device 44 disposed in downstream from the tenter device 43. In the edge slitting device 44, both side edge portions of the film 72 are slit off, and tips of the side edge portions are rushed by a crusher 73. After the edge slitting, the film 72 is fed to the drying device 45 disposed in downstream from the edge slitting device 44.

The drying device 45 has a lot of rollers 75 for guiding the film 72 to the cooling device 46 disposed in downstream from the drying device 45. When the drying is made in the drying device 45, the solvent evaporates from the film 72 to be solvent vapor. The solvent vapor is adsorbed by an adsorbing device 76 disposed outside the drying device 45. The temperature in the drying device 45 is preferably in the range of 50° C. to 160° C.

The film 72 fed out from the drying device 45 is cooled to around a room temperature by the cooling device 46. Between the drying device 45 and the cooling device 46, there are a moisture controller (not shown) for applying to the film 72 an air blow whose temperature and moisture are controlled to predetermined values. Thus the curling of the film and the winding defect in the winding device 47 are prevented.

In downstream from the cooling device 46, a compulsory neutralization device (or a neutralization bar) 80 eliminates the charged electrostatic potential of the film 72 to the predetermined value (for example, in the range of −3 kV to +3 kV). After the neutralization, the embossing of both side portions of the film 72 is made by a knurling roller 81 to provide the knurling. Further, in the winding device 47, there are a winding shaft 82 for winding the film 72 and a press roller 83 for controlling the tension of the film in the winding.

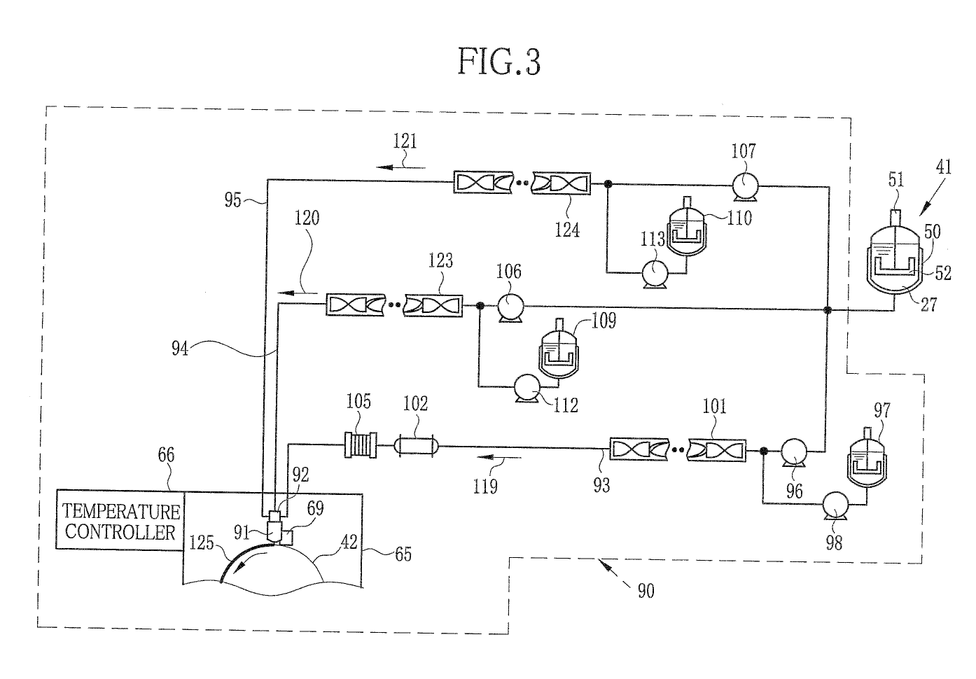

In the first embodiment, the number of the dope to be cast is only one. However, at least two sorts of the dopes may be cast by a co-casting method, a sequentially casting method, or a combination of these two casting methods. In followings, a second embodiment is shown in reference to FIG. 3, in which the co-casting method is made to form a film of three layer structure. Note that the same numbers are applied to the same devices and the same members as in FIG. 2.

In this second embodiment, three sorts of dopes 119-121 for forming a casting film 125 having a three layer structure are prepared from the dope 27 which is prepared in the dope production line 10. The dope 27 is stored in the stock tank 41. The temperature and the concentration of the dope 27 are the same as in the first embodiment. The dope 27 is fed out from the stock tank 41 to first−third feed lines 93-95. In the first feed line 93, the dope 119 is prepared and to be cast onto the cooling drum 42 to form a first layer of the casting film 125. In the second feed line 94, the dope 120 is prepared and cast to form a second layer (not shown) on the first layer. In the third feed line 95, the dope 121 is prepared and cast to form a third layer (not shown) as an exposure layer on the second layer. According to the first dope 119 for forming the first layer, the impurities are precipitated between the stock tank 41 and a casting die 91 for casting the dopes 119-121. However, the precipitation may be made in the dope production line 10. Further, the precipitation of the impurities may be made for all of the dopes 119-121. Furthermore, the number of the layer to be formed may be not restricted in 3, but 2 or at least 4.

On the first feed line 93, there is a pump 96. When the pump 96 is driven, the dope 27 flows from the stock tank 41 through the first feed line 93. Further, an additive tank 97 stores additives for preparing the dope 119, and is connected in-line to the first feed line 93. The additives fed out from the additive tank 97 is added to the dope 27, and then stirred by a static mixer 101. Thus the dope 119 is obtained and cooled by a cooling device 102, such that the temperature of the dope 119 may be around the room temperature.

In downstream from the cooling device 102, there is a filtration device 105 for trapping impurities from the dope 119 by performing the filtration. The impurities contain hemicellulose. The averaged porous diameter, filtration rate, flow rate through filter, primary filtration pressure and secondary filtration pressure are almost the same as the conditions of filtration in the first embodiment. The dope 119 after the filtration is fed to a feed block 92 attached to the casting die 91 for the co-casting. In the feed block 92 attached to the casting die 91, respective passages for the dopes 119-121. The position of each passage is adjusted in accordance with the structure of the casting film designated to be formed. Thus in the feed block 92, the dopes 119-120 are joined and the co-casting thereof from the casting die 91 is made.

On the second feed line 94, there is a pump 106. When the pump 106 is driven, the dope 27 flows from the stock tank 41 through the second feed line 94. Further, an additive tank 109 stores additives for preparing the dope 120, and is connected to the second feed line 94. The additives fed out from an additive tank 109 is added to the dope 27, and then stirred by a static mixer 123. Thus the dope 120 is obtained fed to the feed block 92.

On the third feed line 95, there is a pump 107. When the pump 107 is driven, the dope 27 flows from the stock tank 41 through the third feed line 95. Further, an additive tank 110 stores additives for preparing the dope 121, and is connected to the third feed line 95. The additives fed out from an additive tank 110 is added to the dope 27, and then stirred by a static mixer 124. Thus the dope 121 is obtained fed to the feed block 92.

The additives stocked in the stock tank 97 may be a peeling improver (citric acid ester) for the easier peeling of the casting film 125 from the cooling drum 42, a matting agent for reducing the film adhesion in the film roll in which the film is wound up, and the like, further, the additives stocked in the stock tanks 109, 110 may be not only the additives stored in the additive tank 97, but also a UV absorbing agent, plasticizer, retardation controller and the like.

In the last embodiment, the impurities in the dope 27 are precipitated between the stock tank 41 and the casting die 91. However, instead thereof, the impurities may be precipitated in the dope production line 10, as in the first embodiment. Further, in the last embodiment, the precipitation of the impurities is made to the dope 119 which is to cast onto the surface of the cooling drum 42 directly. However, the precipitation may be made to all of the dopes 119-121. It is to be noted that when the precipitation is made at least to the dope 119 which is to cast onto the surface of the cooling drum 42 directly, the pollution of the film surface that is caused by precipitation of the impurities is prevented.

Further, it is not necessary to restrict that the number of the layers to be formed by the co-casting is three. The number may be more or less. Further, when at least two sorts of the dope are used for the co-casting, a plurality of the dopes may be joined for the co-casting of all the dopes. Otherwise, the dopes may be sequentially cast onto the support. These casting method may be combined adequately.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of lubricants in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 (from [1088] to [1265]) discloses the liquid crystal displays of TN type, STN type, VA type, OCB type, reflective type, and other types in detail. The description may be applied to the present invention. Further, in this publication No. 2005-104148 describes a cellulose acylate film provided with an optical anisotropic layer and that having antireflection and antiglare functions. Further, the produced film can be used as an optical compensation film since being double axial cellulose acylate film provided with adequate optical properties. Further, the optical compensation film can be used as a protective film for a polarizing filter.

In followings, embodiments of the present invention will be explained concretely. However, the present invention is not restricted in them.

### Example 1

In Example 1, the raw materials for the dope were as follows. The solvent was a mixture prepared by previously mixing methylene chloride, methanol and n-butanol, and contained in the solvent tank 11.

| | | |
|---|---|---|
| Cellulose Triacetate | 100 | pts · mass |
| (Powder: degree of substitution, 2.86; viscosity-average | | |
| degree of polymerization, 306; water content, 0.2 mass %; | | |
| viscosity of 6 mass % dichloromethane solution, 315 mPa · s; | | |
| averaged particle diameter, 1.5 mm; standard deviation of | | |
| particle diameter, 0.5 mm) | | |
| Methylene Chloride (first solvent component) | 400 | pts · mass |
| Methanol (second solvent component) | 77 | pts · mass |
| n-butanol (third solvent component) | 5 | pts · mass |
| Plasticizer A (triphenylphosphate) | 7.6 | pts · mass |
| Plasticizer B (diphenylphosphate) | 3.5 | pts · mass |

According to cellulose triacetate used in this experiment, the remaining content of acetic acid was at most 0.1 mass %, the Ca content was 58 ppm, the Mg content was 42 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. Note that the content of the metals are measured by the atomic absorption spectrometry, according to a sample of the cellulose acetate to be used. The acetone extract was 8 mass %, and a ratio of weight-average molecular weight to number-average molecular weight was 2.5. Further, yellow index was 1.7, haze was 0.08, and transparency was 93.5%. Tg (measured by DSC) was 160° C., and calorific value in crystallization was 6.4 J/g. This cellulose triacetate is synthesized from cellulose as material obtained from cotton, and called cotton TAC in the following explanation.

The dope 27 was prepared with use of the mixing tank 12 having first and second stirrers that was made of stainless and 4000 L in volume. Into the mixing tank 12, plural solvent components were mixed such that a mixture solvent was obtained. While the stirring of the mixture solvent was made, the cellulose triacetate flakes were added from the hopper to the mixture solvent gradually, such that the total mass of the mixture solution and the cellulose triacetate flakes might be 2000 kg. Note that the water content in each solvent components is at most 0.5 mass %. The stirring was made with use of the first stirrer having the anchor blade and the second stirrer which was eccentric stirrer of dissolver type. At first, the second stirrer 24 performed the stirring at shear rate at first 5 m/sec (shear stress was 49.0×10⁴ N/m/s²), and the first stirrer 22 performed the stirring at 0.5 m/sec as circumferential velocity (shear stress was 9.8×10⁴ N/m/s²). Thus the dispersion was made for 30 minutes during the stirring. The dissolving started at 25° C., and the temperature of the dispersion became 48° C. at last. After the dispersion, the high speed stirring (of the second stirrer) was stopped, and the stirring was performed by the first stirrer at 0.5 m/sec as circumferential velocity for 100 minutes. Thus cellulose triacetate flakes was swollen such that the swelling liquid was obtained. Until the end of the swelling, the inner pressure of the mixing tank was increased to 0.12 MPa with use of nitrogen gas. At this moment, the hydrogen concentration in the mixing tank was less than 2 vol. %, which does not cause the explosion. Further, water content in the mixture 25 was 0.3 mass %.

The solid contents in the mixture 25 were entirely dissolved by the heating device 15, such that the dope 27 may be obtained. The temperature of the mixture 25 in the heating device 15 was 100° C., and that of the dope 27 was 90° C. The solid content in the dope 27 was 19 mass %. Then the dope 27 at 90° C. was cooled by the cooling device 16 whose inner temperature was −15° C. After the cooling, the temperature of the dope 27 was −8° C. Thus the impurities were precipitated in the dope 27, and contained hemicellulose. The filtration of the dope 27 containing the impurities is made by the filtration device 17, such that impurities may be trapped. The nominal diameter was 10 μm, the primary pressure in the filtration was 3 MPa, and the secondary pressure was 1.6 MPa. When the filtration of the dope 27 of −8° C. was made, the content of the impurities remaining in the filtration device 17 was 149.0 g per 10 L of the dope 27. Thereafter, the dope 27 was cast onto the cooling drum 42, and 1.0 g of the impurities per 10 L of the dope 27 appeared.

The dope 27 was fed into the flush device 30 in which the temperature and the pressure were controlled to 120° C. and the atmospheric pressure, such that the flush evaporation of the polymer solution was made. The solvent vapor was condensed by the condenser to the liquid state, and recovered by the recovering device 32. After the flushing, the content of solid compounds in the polymer solution was 23.0 mass %. Note that the recovered solvent was recycled by the refining device 33 and reused. The anchor blade is provided at a center shaft of a flush tank of the flush device 30, and the polymer solution was stirred by the anchor blade at 0.5 m/sec as circumferential velocity. The temperature of the polymer solution in the flush tank was 25° C., the retaining period of the polymer solution in the flush tank was 50 minutes. The dope 27 was sampled, and the shearing viscosity was measured at 25° C. The result of the measurement was 450 (Pa·s) at 10 (s⁻¹) of the shearing speed.

Then the defoaming was further made by irradiating very weak ultrasonic waves. Thereafter, the polymer solution was fed to the filtration device 31 by the pump 34 under the application of pressure at 1.5 MPa. In the filtration device 31, the polymer solution was fed at first through a sintered fiber metal filter whose nominal diameter was 10 μm, and then through the same filter of 10 μm nominal diameter. At the forward and latter filters, the upstream side filtration pressures were respectively 1.5 MPa and 1.2 MPa, and the downstream side filtration pressures were respectively 1.0 MPa and 0.8 MPa. The temperature of the polymer solution after the filtration was controlled to 36° C., and stored as the dope 27 in the stainless stock tank 41 whose volume was 2000 L. The anchor blade is provided to a center shaft of the stock tank 41, and the dope 27 was always stirred by the anchor blade at 0.3 m/sec as circumferential velocity.

The pump 53 for increasing the primary pressures was high accuracy gear pumps and driven to feed the dope 27 while the feed back control was made by an inverter motor. As for the pump 53, volumetric efficiency was 99.2%, and the variation rate of the discharging was at most 0.5%. Further, the discharging pressure was 1.5 MPa. Then the dope 27 filtrated through the filtration device was fed to the casting die 56.

The flow rate of the dope 27 near a die lip of the casting die 56 is controlled such that the dried film may be 80 μm in thickness, while the viscosity of the dope 27 was 20 Pa≠s. The casting width of the dope 27 from the die lip was 1700 μm. The casting speed was 20 m/min. Further, a jacket (not shown) is provided for the casting die 56. The temperature of a heat transfer medium was controlled to 36° C. at the entrance of the jacket, such that the temperature of the dope 27 may be controlled to 36° C.

The casting die 56 was the coat hunger type, in which heat bolts for adjusting the film thickness were disposed at the pitch of 20 mm. Thus the film thickness (or the thickness of the dopes) is automatically controlled by the heat bolt. A profile of the heat volt can be set corresponding to the flow rate of the high accuracy gear pump, on the basis of the preset program. Thus the feed back control can be made by the control program on the basis of the profile of an infrared ray thickness meter (not shown) disposed in the film production line 40.

In the upstream side of the casting die 56, there is the decompression chamber 69. The decompression rate of the decompression chamber 69 was controlled in accordance with the casting speed, such that the pressure difference might occur in the range of one Pa to 5000 Pa between the upstream and downstream sides of the bead of the cast dope above the casting die. At this time, the pressure difference between both sides of a bead of the cast dope was determined such that the length of the bead might be from 20 mm to 50 mm. Further, the pressure in the upstream side of the running direction of the cooling drum 42 was 150 Pa lower than the downstream side. Furthermore, an instrument was provided such that the temperature of the decompression chamber 69 might be set to be higher than the condensation temperature of the gas around the casting section. Further, the casting die 56 was provided with an edge aspiration device (not shown) for controlling the disorder of the edge portions of the casting bead. The edge aspiration device was adjustable such that the flow rate of the wind might be in the range of 1 L/min to 100 L/min. Furthermore, the decompression chamber 69 is provided with a jacket (not shown) into which a heat transfer medium at 35° C. was fed. Thus the inner temperature of the decompression chamber 69 is kept to a predetermined value.

The cooling drum 42 was 2.1 m in width. The surface of the cooling drum 42 was grinded, such that the surface roughness might be at most 0.05 μm. The material had enough corrosion resistance and strength. The fluctuation of the rotation speed of the cooling drum 42 was at most 0.05% of the predetermined value. The position of the cooling drum 42 in the widthwise direction was controlled with detection of the position of the side end, such that meandering in one circle of the moving cooling drum 42 was reduced in 1.5 mm. The cooling medium providing device 57 circulatory feeds the cooling medium at −30° C. to the cooling drum 42, such that the surface temperature of the cooling drum 42 was controlled to −5° C. The positional fluctuation of the cooling drum 42 below the casting die 56 and the die lip in the vertical direction was 200 μm. The cooling drum 42 is disposed in the casting chamber including a wind pressure controller (not shown).

The cooling drum 42 preferably has no surface defects. Therefore the cooling drum 42 had no pin hole of at least 30 μm, at most one pin hole in the range of 10 μm to 30 μm, and at most two pin holes of less than 10 μm per 1 m². The temperature in the casting chamber 65 is kept to 35° C. In order to make the condensation of the solvent vapor in the casting chamber 65, the condenser 67 was disposed, and the temperature at the exit thereof was −10° C. In the casting chamber 65, an air blower (not shown) was provided for feeding a drying air of at 40° C. and 10% RH at 10 m/min.

When the content of remaining solvent in the casting film 58 became 150 mass %, the casting film 58 was peeled as the wet film 60 from the cooling drum 42 by the roller 59. the temperature of the casting film 58 was −10° C., and a transporting time of the casting film 58 on the cooling drum 42 was 3 seconds. The peeling tension was 98 N/m. In order to reduce the peeling defects, the percentage of the peeling speed (the draw of the peeling roller) to the speed of the cooling drum 42 was controlled from 100.1% to 110%. The drying speed of the casting film 58 on the cooling drum 42 was controlled, so as to be 60 mass %/min in average on dry basis. The solvent vapor generated in the evaporation is condensed by the condenser 67 at −10° C. to a liquid state, and recovered by the recovering device 68. The water content of the recovered solvent was adjusted to at most 0.5%.

In the transfer area 62, the wet film 60 was transported to the tenter device 43 by the rollers 61. Further, the transporting tension of each roller 61 to the wet film 60 was 100 N/width, and the drying air was fed out from the air blower 70 to the wet film 60.

The wet film 60 fed into the tenter device 43 was transported into the drying zone of the tenter device 43 and dried with use of the drying air, while both side edges of the wet film 60 was held by the pin clips. The transference of the pin clips was made with use of chain, and the speed fluctuation of the sprocket was at most 0.5%. The tenter device 43 was partitioned into three zones. The temperature of the drying air in each zone was 90° C., 100° C., 110° C. from the upstream side. According to the gas composition in the drying air, the saturation concentration of the gas was −10° C. The averaged drying speed in the tenter device 43 was 120 mass %/min on the dry basis. The condition of each zone was controlled such that the content of the remaining solvent in the film 72 might be 7 mass % at the exit of the tenter device 43.

In the tenter device 43, the stretching of the wet film 60 in the widthwise direction was made as the transportation was made. If the percentage of the film width before the tenter device 43 was determined to 100%, the stretching ratio of the film width after the tenter device 43 was 103%. Further, the wet film 60 was drawn in the lengthwise direction between the roller 59 and the tenter device 43. The drawing ratio in percentage was 102%. According to the stretching ratio in the tenter device 43, the difference of the actual stretching ratio was at most 10% between two positions which were at least 10 mm apart from the clipping position of the clips, and at most 5% between two positions which were 20 mm apart from the holding portions. The solvent vapor generated in the tenter device 43 was condensed at −10° C. to a liquid state and recovered. For the condensation, a condenser (not shown) was provided, and a temperature at an exit thereof was −8° C. The water content in the recovered solvent was regulated to at most 0.5 mass %, and then the recovered solvent was reused. The wet film 60 was fed out as the film 72 from the tenter device 43.

In the edge slitting device 44, both side edge portions of the film 72 were slit off. In this experiment, each side portion of 50 mm in the widthwise direction of the wet film 60 was determined as the side edge portion, which were slit off by an NT type cutter of the edge slitting device 44. The slit side edge portions were sent to the crusher 73 by applying air blow from a blower (not shown), and crushed to tips about 80 mm². The tips were stored into edge silos (not shown) for reusing as raw material with the TAC flakes for the dope production. The edge silo has a solvent density meter, and the solvent density in the edge silo is displayed on a monitor. If the solvent density in the edge silo is more than 25 vol % as the edge silo LEL (LEL: Lower Explosion Limit), the explosion sometimes happens. However, in this embodiment, the solvent density was always less than 25 vol %, and therefore the explosion couldn't happen. The tips were reused as raw material with the TAC frame for the dope production. The oxygen concentration in the drying atmosphere in the tenter device 43 was kept to 5 vol. %. Note that the air was substituted by nitrogen gas in order to keep the oxygen concentration at 5 vol. %. Before the drying at the high temperature in the drying chamber 54, the pre-heating of the film 72 was made in a pre-heating chamber (not shown in which the air blow at 100° C. was supplied.

The film 72 was dried at high temperature in the drying chamber 64, which was partitioned into four partitions. Air blows whose temperatures were 120° C., 130° C., 130° C. and 130° C. from the upstream side were fed from air blowers (not shown) to the partitions. The transporting tension of each roller 75 that was applied to the film 72 was 100 N/width. The drying was made for ten minutes such that the content of the remaining solvent might be 0.3 mass %. The lapping angle on the roller 75 was 90° and 180°. The rollers 75 were made of aluminum or carbon steel. On the surface, the hard chrome coating was made. The surfaces of the rollers 75 were smooth or processed by blast of matting process. The swing of the roller in the rotation was in 50 μm. Further, the bending of the roller 75 at the tension of 100 N/width was reduced to at most 0.5 mm.

The solvent vapor contained in the drying air is removed with use of the adsorbing device 76 in which an adsorbing agent was used. The adsorbing agent was active carbon, and the desorption was performed with use of dried nitrogen. The recovered solvent was reuse as the solvent for the dope preparation after the water content might be at most 0.3 mass %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 mass %, and almost of the remaining solvent vapor was recovered by the adsorption recovering.

The film 72 was transported through first and second moisture controlling chambers (not shown) that were disposed between the drying chamber 64 and the cooling chamber 65. Thus the moisture of the film 72 was controlled such that the curling might be reduced. In the first moisture controlling chamber, the air whose temperature was 50° C. and dewing point was 20° C. was fed. Further, the film 72 was fed into a second moisture chamber (not shown) in which the curling of the film 72 was reduced. An air whose temperature was 90° C. and humidity was 70% was applied to the film 72 in the second moisture controlling chamber.

After the moisture adjustment, the film 72 was cooled to at most 30° C. in the cooling device 46, and then the edge slitting was performed. The compulsory neutralization device (or a neutralization bar) 80 was provided, such that in the transportation, the charged electrostatic potential of the film might be in the range of −3 kV to +3 kV. Further, the film knurling was made on a surface of each side of the film 72 by the knurling roller 81. The width of the knurling was 10 mm, and the knurling pressure was set such that the height from bottom to top of the film surface might be at most 12 μm larger in average than the averaged thickness.

The film 72 was transported to the winding device 47. The diameter of the winding shaft 82 was 169 mm. The tension pattern was set such that the winding tension was 300 N/m at first, and 200 N/m at last. The obtained film 72 was 1340 mm in width, and the inside between the knurling parts was 1313 m. The temperature of the film at the winding was 23° C., the water content was 1.0 mass %, and the content of the remaining solvent was 1 mass %. The inside temperature and humidity of the winding device 47 were respectively kept to 28° C. and 70%. Further, a compulsory neutralization device (not shown) was provided, such that the charged electrostatic potential of the film might be in the range of −1.5 kV to +1.5 kV. The cycle of winding dislocation was 400 m, and the oscillation width was in ±5 mm. Further, the pressure of the press roller 83 to the winding shaft 82 was set to 50 N/m. Through all processes, according to the drying speed, 20 mass % of the solvent in dry weight standard was evaporated per minute in average. Note that the production speed was 50 m/min because of the winding speed in the winding device 47.

### Example 2

In Example 2, the co-casting of the dope 27 was made, such that the film 72 may be produced. Note that the raw materials were the same as Example 1. The dope production line 10 was not provided with the cooling device 16. However, as shown in FIG. 3, the cooling device 102 was disposed on the first feed line 93 in the film production line 90, so as to cool the dope 119. Other conditions were the same as Example 1.

The temperature of the stock tank was 35° C., and the dope 27 stored therein was 34° C. The solid content in the dope 27 was 23 mass %. The temperature of the cooling device 102 was −10° C., and the temperature of the cooled dope 27 was −8° C. The dope 119 flowing in the first feed line 93 is cooled such that the impurities containing hemicellulose precipitated. The filtration of the dope 119 was made with use of the filtration device 105 such that the impurities and the foreign materials were trapped. The nominal diameter, the primary pressure and the secondary pressure were the same as Example 1. When the filtration of 10 L of the dope 119 at 8° C. was performed, the amount of impurities remaining in the filtration device 105 was 149.75 g. Further, after the trap of the impurities, the amount of the pollution precipitated from 10 L of the dope 119 on the cooling drum 42 was 0.25 g. In view of reducing the pollution on the cooling drum 42, the co-casting is preferably made to the single layer casting of the dope.

[Comparison]

If the cooling device 16 is not provided in downstream from the heating device 15, the impurities in the dope 27 cannot be precipitated in the dope production line 10. In this case, the dope was heated to 35° C. by the heating device 15, and then 100 g of the impurities per 10 L of the dope 27 was trapped by the filtration device 17. Thereafter, the dope 27 was cast onto the cooling drum 42, and 50 g of the impurities per 10 L of the dope 27 appeared. As the result, when the precipitation of the impurities in the dope 27 is made in the dope production line 10, the precipitation of the impurities on the cooling drum 42 is reduced. Thus the pollution of the cooling drum 42 is almost prevented.

Various changes and modifications are possible in the present invention and may be understood to be within the present invention.

1. A production method of a polymer film, comprising steps of:
mixing a polymer and a solvent such that a swelling liquid in which said polymer is swollen by said solvent may be obtained;
heating said swelling liquid, so as to produce a casting dope;
cooling said casting dope to about a surface temperature of said support such that impurities may be precipitated in said casting dope;
trapping said impurities from said casting dope;
casting said casting dope onto a support, so as to form a casting film; and
drying said casting film so as to obtain a polymer film.

2. A production method described in claim 1,
wherein said casting film has a multi-structure having a first film contacting to said support and a second layer disposed on said first film; and
wherein said first layer is formed from said casting dope after the cooling step and the trapping step.

3. A production method described in claim 1,
wherein said casting dope is cooled in the cooling step to a temperature in the range of a surface temperature of said support and 38° C., and
wherein the trapping is made by a filtration.

4. A production method described in claim 1, wherein a surface temperature of said support is in the range of −30 to 0° C.

5. A production method described in claim 1, wherein a temperature of said swelling liquid during the heating is in the range of 40° C. to 120° C.

6. A production method described in claim 1, wherein a poor solvent containing hydroxyl group is added to said casting dope after the trapping step.

7. A production method described in claim 1, further comprising concentrating said casting dope.

8. A production method described in claim 7, wherein the trapping step is made after the concentrating step.

9. A production method described in claim 1, wherein said impurities contain hemicellulose.
